(19) United States
(12) Patent Application Publication
(10) Pub. No.: US 2010/0316780 A1
(43) Pub. Date: Dec. 16, 2010

(54) METHOD AND COMPOSITION FOR FOOD PRESERVATION

(76) Inventors: Leon Corbin, Florissant, MO (US); George E. Hudspeth, JR., Saint Louis, MO (US); John B. Holman, University City, MO (US)

Correspondence Address: Patent Docket Department;Armstrong Teasdale LLP, 7700 Forsyth Boulevard, Suite 1800, St. Louis, MO, 63105, US

(21) Appl. No.: 12/483,333

(22) Filed: Jun. 12, 2009

(51) Int. Cl. A23B 4/18; A23B 4/10; A23B 4/12

(52) U.S. Cl. 426/332; 426/652

(57) ABSTRACT

A composition is provided for use with a food product. The composition includes an acidic solution adapted to permeate the food product, and an oil mixed with the acidic solution, wherein the oil is adapted to form a coating along at least a portion of an outer surface of the food product after being applied to the food product.

### BACKGROUND OF THE INVENTION

The embodiments described herein relate generally to food preservatives and, more particularly, to a preservative mixture that may be used to simultaneously reduce or retard growth of microbes, prevent dehydration, and tenderize a food product.

At least some known food processing methods include treating food products, such as meat, poultry, and seafood, with a solution that contains an alkali metal ortho-phosphate prior to chilling. Moreover, at least some known methods include treating the food products with solutions that include substances such as lactic acid, sodium carbonate, sodium borate, and/or sodium chloride. Other similar methods include applying chemicals, such as peroxyacetic acid, peroxyoctanoic acid, and/or hydrogen peroxide to food products during processing and/or prior to storage. However, such known processing methods often change the visual acceptability of the food products by, for example, changing the color.

Moreover, at least some known preservative formulations are applied to a food product in the form of a spray to facilitate preventing the growth of microorganisms. Such formulations may also be administered to food preparation surfaces. Other known preservation methods include introducing a predetermined amount of euhygienic non-pathogenic, non-spoilage bacteria to inhibit the growth of undesired pathogenic and/or spoilage bacteria. Moreover, in some of such methods, the non-pathogenic, non-spoilage bacteria is introduced by applying an edible film to the food product prior to storing the food product. As such, the bacteria may also be introduced to consumers. However, known formulations and methods do not form a protective coating around the food product while simultaneously tenderizing the food product and preventing microorganism growth.

### BRIEF DESCRIPTION OF THE INVENTION

This Brief Description is provided to introduce a selection of concepts in a simplified form that are further described below in the Detailed Description. This Brief Description is not intended to identify key features or essential features of the claimed subject matter, nor is it intended to be used as an aid in determining the scope of the claimed subject matter.

In one aspect, a composition is provided for use with a food product. The composition contains an acidic solution adapted to permeate the food product, and an oil mixed with the acidic solution, wherein the oil is adapted to form a coating along at least a portion of an outer surface of the food product after being applied to the food product.

In another aspect, a food preservation method is provided. The method includes providing an acidic solution, providing an oil, and mixing the acidic solution and the oil to form a preservative mixture. The method also includes applying the mixture to a food product such that the acidic solution permeates the food product and such that the oil forms a coating along an outer surface of the food product.

In another aspect, a food preparation method is provided. The method includes providing an acidic solution, providing an oil, providing an antimicrobial agent, and mixing the acidic solution, the oil, and the antimicrobial agent. The method also includes applying the mixture to a food product such that the acidic solution permeates the food product and such that the oil forms a coating along an outer surface of the food product.

### DETAILED DESCRIPTION OF THE INVENTION

Exemplary applications of methods and compositions according to the present invention are described herein. These examples are provided solely to add context and to aid in the understanding of the invention. It will thus be apparent to one skilled in the art that the present invention may be practiced without some or all of these specific details. In other instances, well known process steps have not been described in detail in order to avoid unnecessarily obscuring the present invention. Other applications are possible, such that the following example should not be taken as definitive or limiting either in scope or setting. In the detailed description that follows, references are made to the accompanying drawings, which form a part of the description and in which are shown, by way of illustration, specific embodiments of the present invention. Although these embodiments are described in sufficient detail to enable one skilled in the art to practice the invention, it is understood that these examples are not limiting, such that other embodiments may be used and changes may be made without departing from the spirit and scope of the invention.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, as used herein, the term “food product” refers generally to any suitable form of food, including meats, poultry, seafood, and/or any other suitable product. Meats may include beef parts, pork, lamb, wild game, or any other suitable form. Poultry may include any form of bird kept, harvested, or domesticated for meat and/or eggs. Seafood may include any fish, shellfish, or any other form of food that is caught or harvested in water, including fresh water and salt water.

In one aspect, the present invention provides a composition that may be used to preserve a food product. In addition, the same composition facilitates the prevention of freezer burn and the reduction of microbial contamination of a food product. In the exemplary embodiment, the composition contains an acidic solution that contains a predetermined amount of vinegar. Moreover, the vinegar contains a predetermined concentration of acetic acid. For example, the acetic acid concentration of the vinegar may be within a range of approximately 4.0 percent by volume to approximately 8.0 percent by volume. However, higher or lower concentrations of acetic acid may be used. The acidic solution also contains a predetermined amount of water. In the exemplary embodiment, when the composition is applied to the food product, the acidic solution is absorbed by the food product and permeates an interior of the food product. Moreover, as the acidic solution permeates the food product, the acetic acid begins to break down connective tissue within the food product, thereby tenderizing the food product. Furthermore, the acetic acid does not require an activation or catalyst, such as heat, to permeate the food product nor to break down the connective tissue. However, in one embodiment, heat may further accelerate the permeation. In the exemplary embodiment, the water within the acidic solution facilitates increasing moisture in the interior of the food product, thereby reducing effects of evaporation, such as freezer burn and/or excessive drying that may occur during cooking.

Moreover, in the exemplary embodiment, the composition contains a predetermined amount of an oil. When the composition is applied to the food product, the oil creates a coating along at least a portion of an outer surface of the food product. The coating further facilitates reducing evaporation of moisture from the food product and thereby reduces the effects of such evaporation, including freezer burn and/or excessive drying during cooking. In one embodiment, the oil is soybean oil. However, any suitable oil may be used including, but not limited to only including, vegetable oil, peanut oil, olive oil, canola oil, corn oil, pumpkin seed oil, sunflower oil, grape seed oil, or any other oil that creates a desirable coating along the surface of the food product.

In the exemplary embodiment, the composition also contains an antimicrobial agent. The antimicrobial agent reduces microbial contamination on the outer surface of the food product and/or within the flesh of the food product. The antimicrobial agent may be any suitable ingredient that serves to reduce a count of microbes, such as salmonella, on or within the food product. Moreover, the antimicrobial agent may consist of a single ingredient or may be a combination of multiple ingredients. Such ingredients include, but are not limited to only including, peppers, onions, garlic, seeds, fruits or fruit juices, and/or any other suitable spices. Peppers that may be used as ingredients of the antimicrobial agent may include any capsicums, such as chili peppers. Seeds that may be used as ingredients of the antimicrobial agent include, but are not limited to, mustard seeds, caraway seeds, fennel seeds, anise seed, and/or celery seed. In addition, the seeds may be crushed, in powder form, or in any other suitable form. Fruits or fruit juices that may be used as ingredients of the antimicrobial agent include, but are not limited to, lime and/or lemon. Spices that may be used as ingredients of the antimicrobial agent include, but are not limited to, allspice, oregano, thyme, cinnamon, tarragon, cumin, cloves, lemon grass, bay leaf, rosemary, marjoram, mint, sage, coriander, dill, nutmeg, basil, parsley, cardamom, ginger, white pepper, and/or black pepper. The antimicrobial agent may contain any one or more of the above ingredients in a natural state, in an extract, in a concentrated form, or in any combination of the aforementioned.

Furthermore, in the exemplary embodiment, the composition also contains a preservative. The preservative facilitates slowing or stopping spoilage of the food product. Such spoilage may be due to growth of bacteria or other microbes on or within the food product, or may be due to an oxidation of fats within the food product. The preservative also facilitates inhibiting natural aging and/or discoloration, such as natural browning of food products. In one embodiment, the preservative contains a predetermined amount of salt. The salt draws moisture out of the food product via osmosis. In another embodiment, the preservative contains a predetermined amount of nitrates or nitrites that facilitate preserving the food product and inhibiting growth of bacteria such as Clostridium botulinum. In another embodiment, the preservative contains an edible anti-microbial liquid that facilitates inhibiting growth of bacteria and/or other microorganisms. Examples of such liquids include brine, vinegar, alcohol, and vegetable oil. As such, in some embodiments, the acidic liquid, the antimicrobial agent, and/or the preservative may consist of the same ingredient or combination of ingredients.

In another aspect, the present invention provides a method for preserving a food product using the composition described above. The method also facilitates preventing freezer burn, reduces microbial contamination of a food product, and seasons and tenderizes the food product. In some embodiments, the method includes cleaning the food product to remove at least a first layer of contaminants and/or microbes. In the exemplary embodiment, the method includes providing an acidic solution that contains a predetermined amount of vinegar. The vinegar contains a predetermined concentration of acetic acid and a predetermined amount of water. Moreover, in the exemplary embodiment, the method includes providing a predetermined amount of an oil. In one embodiment, the oil is soybean oil. However, any suitable oil may be used including, but not limited to only including, vegetable oil, peanut oil, olive oil, canola oil, corn oil, pumpkin seed oil, sunflower oil, grape seed oil, and/or any other oil that creates a desirable coating along the surface of the food product.

In the exemplary embodiment, the method also includes providing an antimicrobial agent. As described above, the antimicrobial agent may be any suitable ingredient that facilitates reducing an amount of microbes, such as salmonella, on or within the food product. Moreover, the antimicrobial agent may consist of a single ingredient or may be a combination of multiple ingredients. The antimicrobial agent may contain any one or more of the ingredients described herein in a natural state, in an extract, in a concentrated form, or in any combination of the aforementioned.

Furthermore, in the exemplary embodiment, the method includes mixing the above-described elements together to form a preservative mixture, and applying the mixture to a food product. The preservative mixture may be formed using any suitable technique for combining ingredients. For example, the preservative mixture may be formed by stirring the ingredients together or through any other method of agitation. As another example, the preservative mixture may be formed by combining the ingredients and heating the combination to a predetermined temperature. When the mixture is applied to a food product, the acidic solution is absorbed by the food product and permeates an interior of the food product. Moreover, as the acidic solution permeates the food product, the acetic acid begins to break down connective tissue within the food product, thereby tenderizing the food product. Furthermore, the acetic acid does not require an activation or catalyst, such as heat, to permeate the food product nor to break down the connective tissue. However, in one embodiment, heat may further accelerate the permeation. In the exemplary embodiment, the water within the acidic solution facilitates increasing a moisture level in the interior of the food product, thereby reducing effects of evaporation, such as freezer burn and/or excessive drying during cooking. Moreover, when the mixture is applied to a food product, the oil creates a coating along at least a portion of an outer surface of the food product. The coating facilitates reducing evaporation of moisture from the food product, thereby reducing effects of such evaporation, including freezer burn and/or excessive drying during cooking. In addition, the antimicrobial agent reduces microbial contamination on the surface of the food product and/or within the flesh of the food product.

In yet another aspect, the present invention provides a method for preparing a food product using the composition described herein. The method facilitates preventing freezer burn on or within the prepared food product and facilitates reducing microbial contamination of the food product when raw and when cooked. In the exemplary embodiment, the composition is provided using the methods described above. The preparation method also includes applying the composition to the food product and cooking the food product. In some embodiments, the composition may be applied by soaking the food product in the composition for a predetermined amount of time. However, the order in which the composition is applied to the food product and the food product is cooked may differ. For example, in one embodiment, the composition is applied to the food product prior to cooking. Alternatively, the composition may be applied immediately before cooking the food product or may be applied to the food product a predetermined time prior to cooking. In another embodiment, the food product is cooked and then the composition is applied to the cooked food product. In another embodiment, the food product is partially cooked, the composition is applied to the partially-cooked food product, and then the food product is allowed to finish cooking.

Moreover, in some embodiments, the method also includes freezing the food product. For example, the food product may be frozen before applying the composition and before being cooked. Alternatively, the food product may be frozen after applying the composition and before cooking. In another example, the food product may be frozen after the composition is applied and after the food product is cooked.

The methods and compositions described herein facilitate preserving food products, such as meat and poultry. Moreover, the methods and compositions may be used after processing the food products and/or before packaging and shipping the food products. Furthermore, the methods and compositions described herein facilitate protecting food products from dehydration while frozen, as well as reducing a count of microbes and/or bacteria that are present on the food product. In addition, the method and compositions permeate the food products without requiring puncturing or other damaging techniques be used. The compositions described herein do not require additional oil be used during the chosen cooking process or additional seasoning for taste. Natural moisture of food products may be restored using the compositions described herein. The methods and compositions described herein also facilitate preventing cross-contamination of different food products being prepared simultaneously. For example, the composition described herein may be simultaneously applied to two or more different food products, such as chicken and beef, thereby facilitating protecting the two or more food products from dehydration, reducing the count of microbes, bacteria, and/or contaminants present on the two or more food products, and tenderizing and seasoning the two or more food products as described above.

When introducing elements of aspects of the invention or embodiments thereof, the articles “a,” “an,” “the,” and “said” are intended to mean that there are one or more of the elements. The terms “comprising,” including,” and “having” are intended to be inclusive and mean that there may be additional elements other than the listed elements.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A composition for use with a food product, said composition comprising:
an acidic solution adapted to permeate the food product; and
an oil mixed with the acidic solution, wherein the oil is adapted to form a coating along at least a portion of an outer surface of the food product after being applied to the food product.

2. A composition in accordance with claim 1, wherein the acidic solution comprises vinegar.

3. A composition in accordance with claim 1, wherein the acidic solution permeates the food product without an activation.

4. A composition in accordance with claim 1, wherein the acidic solution permeates the food product to facilitate breaking down connective tissue within the food product.

5. A composition in accordance with claim 1, wherein the acidic solution comprises water, and wherein the acidic solution permeates the food product to facilitate reducing dehydration within the food product when frozen.

6. A composition in accordance with claim 5, wherein the coating formed by the oil facilitates reducing dehydration by reducing an amount of water evaporation from the food product.

7. A composition in accordance with claim 1, further comprising an antimicrobial agent adapted to reduce microbial contamination within the food product.

8. A food preservation method comprising:
providing an acidic solution;
providing an oil;
mixing the acidic solution and the oil to form a preservative mixture; and
applying the mixture to a food product such that the acidic solution permeates the food product and such that the oil forms a coating along an outer surface of the food product.

9. A food preservation method in accordance with claim 8, wherein providing an acidic solution comprises providing an acidic liquid and mixing the acidic liquid with water.

10. A food preservation method in accordance with claim 9, wherein providing the acidic liquid comprises providing a vinegar.

11. A food preservation method in accordance with claim 9, further comprising reducing dehydration within the food product, wherein the water permeates the food product and the coating formed by the oil facilitates reducing an amount of water lost within the food product due to evaporation.

12. A food preservation method in accordance with claim 8, further comprising breaking down connective tissue within the food product using the acidic liquid.

13. A food preservation method in accordance with claim 8, wherein providing an oil comprises providing soy oil.

14. A food preservation method in accordance with claim 8, further comprising providing an antimicrobial agent, and mixing the antimicrobial agent with the oil and the acidic solution.

15. A food preservation method in accordance with claim 14, further comprising reducing microbial contamination using the antimicrobial agent.

16. A food preparation method comprising:
providing an acidic solution;
providing an oil;
providing an antimicrobial agent;
mixing the acidic solution, the oil, and the antimicrobial agent; and
applying the mixture to a food product such that the acidic solution permeates the food product and such that the oil forms a coating along an outer surface of the food product.

17. A food preparation method in accordance with claim 16, further comprising cooking the food product after applying the mixture to the food product.

18. A food preparation method in accordance with claim 16, further comprising cooking the food product prior to applying the mixture to the food product.

19. A food preparation method in accordance with claim 16, further comprising partially cooking the food product prior to applying the mixture to the food product, and partially cooking the food product after applying the mixture to the food product.

20. A food preparation method in accordance with claim 16, further comprising soaking the food product in the mixture for a predetermined amount of time.
